(19) United States
(12) Patent Application Publication
(10) Pub. No.: US 2024/0354506 A1
(43) Pub. Date: Oct. 24, 2024

(54) SYSTEMS AND METHODS FOR PARAMETRIC CONTENT GENERATION

(71) Applicant: OJOO Limited, Nicosia (CY)

(72) Inventors: Michal Krystyanczuk, Levallois-Perret (FR); Anastasios Frantzolas, Brooklyn, NY (US)

(73) Assignee: OJOO Limited, Nicosia (CY)

(21) Appl. No.: 18/138,166

(22) Filed: Apr. 24, 2023

(51) Int. Cl. G06F 40/289; G06F 40/242; G06F 40/40

(52) U.S. Cl. CPC G06F 40/289; G06F 40/242; G06F 40/40

(57) ABSTRACT

According to some embodiments, a method is provided comprising receiving input provided by a user to a user device, the input comprising an input text that is at least a part of a line of lyrics; generating one or more proposals for a subsequent line of lyrics for the song and outputting, for transmission to the user device over the network, the one or more proposals for the subsequent line of lyrics for the song.

### FIELD

The present disclosure relates generally to machine learning driven lyric generation that aims in helping artists in their creative process.

### BACKGROUND

Many artists suffer from what is often called ‘writer's block’. It can be described as a lack of inspiration, a feeling of being overwhelmed, or, in extreme cases, even fearful of writing. But in most cases, it's simply a lack of new ideas. Artists need ideas like the soil needs fertilizer. AI can help by giving a much-needed creative boost. A lyrics tool that uses AI can provide a vast array of sentences and unexpected ideas. These new ideas can lay the foundation of a new song or take a song in a completely new direction.

Writing a song takes time for most people. Especially for young and inexperienced songwriters, it can take hours and it's something that makes some people quit even before they get a chance to become great. Writing faster is something that would allow artists to write more songs and be more efficient with their time. Many songwriters like to work with a co-writer to help them write and finish songs. This is a beautifully collaborative process that often happens in a studio, where artist collaborators ‘bounce’ ideas off of each other (the equivalent of a brainstorm).

On one hand, this human interaction is beautiful, satisfying, and special and cannot be fully replicated by a computer. On the other hand, using a software-based ‘co-writer’ instead of a human can have many advantages: you don't need to meet other people to work with you, which is a challenge for some people, the computer is available 24/7 and has an infinite amount of energy, and the deep learning algorithm has accumulated knowledge by learning from hundreds of thousands of books, lyrics, and dictionaries and has them stored in its memory.

### SUMMARY

Embodiments described herein relate to a novel approach to an Artificial Intelligence (AI) driven lyrics generation tool that aims in helping artists in their creative process. More specifically, it implements a pipeline of the machine and deep learning models as well as a scalable infrastructure.

Some embodiments described herein provide users with real-time rhyme recommendations, wordbrain creative keywords and phrases, and sentence-level recommendations. The algorithm generating sentences should cover two types of datasets: generic (trained on lyrics) and user style-based. The platform should also offer a plagiarism check feature that leverages the power of semantic analysis and natural language processing methods. The work on the platform may be divided into functional pieces, which are functioning as separate and independent modules. Each piece is delivered at a different stage of the project: Stage 1—Rhymes recommendations, Wordbrain recommendations; Stage 2—Sentence recommendations; and Stage 3—User-style sentence recommendations.

### BRIEF DESCRIPTION OF THE DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 illustrates a rhyme recommendation pipeline according to some embodiments.

FIG. 2 illustrates a wordbrain pipeline according to some embodiments.

FIG. 3 illustrates a plagiarism detection pipeline according to some embodiments.

FIG. 4 illustrates an API architecture schema according to some embodiments.

FIG. 5 illustrates an workers architecture schema according to some embodiments.

FIG. 6 is a block diagram of a computer system according to some embodiments.

### DETAILED DESCRIPTION

Described herein are various embodiments of techniques for AI-based parametric content generation. In the embodiments, the infrastructure and pipelines have to fulfill all the technical requirements in terms of stability, performance, and security. The architecture design has been split into two main parts which assure that the whole system is working in a scalable way: Pipelines and API infrastructure. In some embodiments, Pipelines implement the AI (Artificial Intelligence) logic within each worker and is crucial to define the infrastructural needs and optimize the computational flow. In some embodiments, API Infrastructure implements all the concepts related to the physical and logical architecture of the system as a whole. It is designed in a scalable and secure manner. Each module implements different processing Steps which can be run sequentially.

### Models

Research problem definition: We can define 4 research problems that could be combined in order to build a rhymes recommender system:
1. —pronunciation detection
2. —algorithmic rhyming
3. —semantic keywords recommendation
4. —phrase generations

Pronunciation detection: Rap music very often uses slang words and neologism in lyric writing. The main challenge of the AI algorithms recommending rhymes is to properly understand the pronunciation of each word even if it doesn't exist in the dictionary. The challenge of pronunciation understanding is defined as the Grapheme to Phoneme conversion problem. We analyzed several approaches to choose the one which gives us the highest chance to succeed. Initially, we focused on the work proceedings from SIGMORPHON 2020 Shared Task on Multilingual Grapheme-to-Phoneme Conversion (Gorman, Kyle, Lucas F. E. Ashby, Aaron Goyzueta, Arya D. McCarthy, Shijie Wu and Daniel You, 2020), (Makarov, Peter, and S. Clematide, 2020) which proposed to use seq2seq models to solve this task. We also used technical concepts presented in Yu, Mingzhi, Hieu Duy Nguyen, Alex Sokolov, Jack Lepird, Kanthashree Mysore Sathyendra, Samridhi Choudhary, A. Mouchtaris, and S. Kunzmann, 2020, and Sun, Hao, Xu Tan, Jun-Wei Gan, Hongzhi Liu, Sheng Zhao, Tao Qin, and Tie-Yan Liu., 2019 to create a TensorFlow implementation of the deep learning model. Based on the results presented in the papers, we decided to use word error rate as a measure of the algorithm performance during training. In some embodiments, it is being computed as follows:

$$W S R = \frac{S + D + I}{N} = \frac{S + D + I}{S + D + C}$$

### Where:

1. S is the number of substitutions,
2. D is the number of deletions,
3. I is the number of insertions,
4. C is the number of correct words,
5. N is the number of words in the reference (N=S+D+C)

In the initial test of the algorithm, we obtained the WER of 20.1 The results coming from the pronunciation detection model will be used as an input to algorithmic rhyming.

### Algorithmic Rhyming

The algorithm for rhyme candidate search is mostly based on the work presented in a paper “A System for the Automatic Identification of Rhymes in English Text” (Buda, 2004) which proves the efficiency of algorithmic rhyme search in English. In some versions, the algorithms follow a specific pipeline of operations:
1. CMU-dict-slang-beatopia dictionary lookup
2. Phonemes to syllables transformation
3. Determining if two syllables rhyme (depending on the type of rhyme)
4. Rhymes post-processing (cleaning)

The evaluation metric can be a confusion matrix on manually labeled rhymes. In some embodiments, the algorithm is successful if it exceeds 90% accuracy.

### Semantic Keyword Recommendation

The semantic keyword recommendation can be defined in two ways:—next word generation problem (generative models)—gap filling.

After the analysis of research literature, we may decide that gap-filling is more adequate to our challenge than text generation. Although generative models such as GPT-2 or GPT-3 are very efficient in predicting the next word for a sentence, our current goal is to suggest creative phrases for the current context of lyrics. For that purpose, we investigated different approaches such as BART (Mustar et al, 2020), BERT (Devlin et al., 2019), ROBERT (Liu et al, 2019), XLM-Roberta (Ou et al, 2020) to find the best approach for that matches the usability criteria. As we are looking for recommendations that are relevant in user context rather than creative, new expressions, we may keep 4 approaches for further tests that will be evaluated by usability scores. In some embodiments, we may train additional machine learning algorithms.

### Phrase Generator

Automatic Phrase Generation is considered a complex Natural Language Processing task and requires an important adjustment to fit a very specific task of lyrics generation. In some versions, we fine-tune a GPT-2 model to generate song lyrics in the style of a particular artist. Our rationale behind using GPT-2 is that it achieved state-of-the-art results on many language modeling tasks including those that involve text generation similar enough to our current task, such as lyrics generation, and the model can be easily trained on a specific task like ours. We can use an LSTM approach as a baseline that could leverage its strong capabilities in sequence forecasting tasks thanks to the capacity of remembering long-term information is crucial for our lyrics generation task. We may also fine-tune the baseline model to generate song lyrics given an artist's context and style. When generating song lyrics, we may format our input to the model as a sequence of tokens to the decoder: ‘?? ’. The pretraining can be done by using a standard language modeling objective to maximize the likelihood L; (U)=5>,_; log P (ui|ui-x, . . . , Ui−1; 8) where U is an unsupervised corpus of tokens. A multilayer Transformer decoder applies multi-headed attention over the input context tokens followed by position-wise feedforward layers to produce an output distribution over target tokens:

$${h}_{0} = {UW}_{e} + {W}_{p}$$

$${h}_{l} = transformer - block ( {h}_{l - 1} ) ∀ i ∈ [ 1 , n ]$$

$$P ( u ) = softmax ( {h}_{n} {W}_{e}^{T} )$$

Where U=(u_x, . . . , u−1) is the context vector of tokens, n is the number of layers, W, is the token embedding matrix, and Wp is the position embedding matrix. We then may fine-tune the OpenAI GPT-2 model on our lyrics generation task. When fine-tuning, we may format the input to the model as ‘?? ’. We use the model to generate lyrics the same way we used our baseline model. We finetuned and used the OpenAI GPT-2 model. The following objective function is maximized during fine-tuning:

$${L}_{2} ( C ) = {\sum }_{( x , y )} log P ( y \vert {x}^{1} , … , {x}^{m} )$$

where h} is the final transformer block's activation and W, are the parameters of the added linear output layer. For our second type of model, we may implement a long short-term memory (LSTM). Because we are aiming to generate lyrics that correspond well to a given artist's style, we model this as a sequence-to-sequence (Seq2Seq) problem. The source is an existing lyric for a given artist, and the target is the lyric generated for the artist's context. Note that the encoder is bidirectional, while the decoder is unidirectional.

We could add an additional classification layer to the model in order to be able to check if a recommendation is usable for a user. For that purpose, we may use a classifier based on BERT model and a dataset created by various testers.

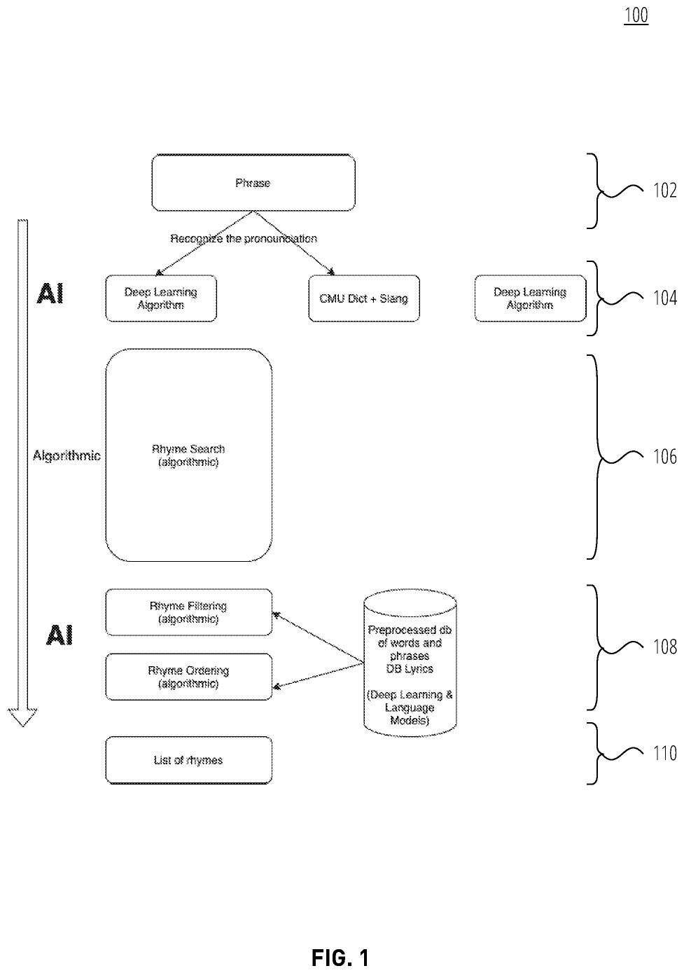

FIG. 1 illustrates a rhyme recommendation pipeline according to some embodiments.

According to some embodiments, a Rhymes Recommender pipeline 100 can be built in four main steps. In Step 102, the input to the system consists of a phrase (textual data) and in certain embodiments, in Step 104 the text sequence is translated into a phoneme sequence. There are two different methods that could be used to perform this task: Dictionary-based—the system searches for pronunciation within a predefined dictionary (Beatopia Pronunciation Dictionary). If it finds a corresponding word, it uses its pronunciations. Model-based-if the word is not found in the dictionary, the pipeline launches a deep learning model which provides the pronunciation.

In Step 106, the system performs a complex phoneme and stress matching for different types of rhymes: perfect rhymes, near rhymes, syllabic rhymes, assonance rhymes, identical rhymes, syllabic rhymes, and consonance rhymes. In some embodiments, as an output, it returns a large list of all possible candidates for rhymes.

In Step 108, the algorithm may perform rhyme filtering. It can check which words exist in a pre-built index containing the entire dictionary of rap songs rhymes. At the end of the processing, it returns a list of rhymes that appear in rap songs.

In Step 110, the last part of the process consists of selecting and ranking the most relevant rhymes. Firstly, the rhymes are divided into two groups: perfect & near rhymes, and others. The final list of rhymes consists of 70% of the rhymes from group 1 ordered by the frequency in the rap dictionary, and the remaining part from group 2 is also ordered by the number of occurrences from group 2. In some embodiments, the final list of rhymes is cleaned by removing stopwords and bad words.

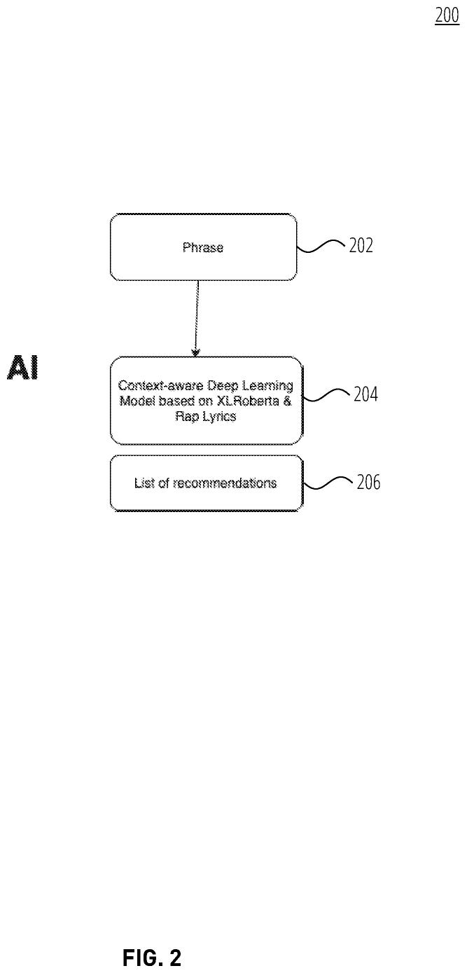

FIG. 2 illustrates a wordbrain pipeline according to some embodiments.

According to some embodiments, a wordbrain pipeline 100 can implement a flow to suggest creative associations with the last written line of the lyrics. In Step 202, the input to the system consists of a phrase (textual data). In some embodiments, in Step 204, the core engine could be based on a fine-tuned XLM-Roberta (Conneau, Alexis, et al. 2020) deep learning model. In some embodiments, the proposed model showed the best performance in terms of user experience during the test, comparing it with BERT, Roberta, and BART models. In some embodiments, the wordbrain recommendations could be completed by a list of dictionary based synonyms and antonyms as well as the vocabulary from different publicly available urban dictionaries. It assures that the suggestions are up-to-date with a fast-changing spoken language. This could be an important feature in the context of rap rhymes generation. In some embodiments, in Step 206, the output of the model is a list of recommendations.

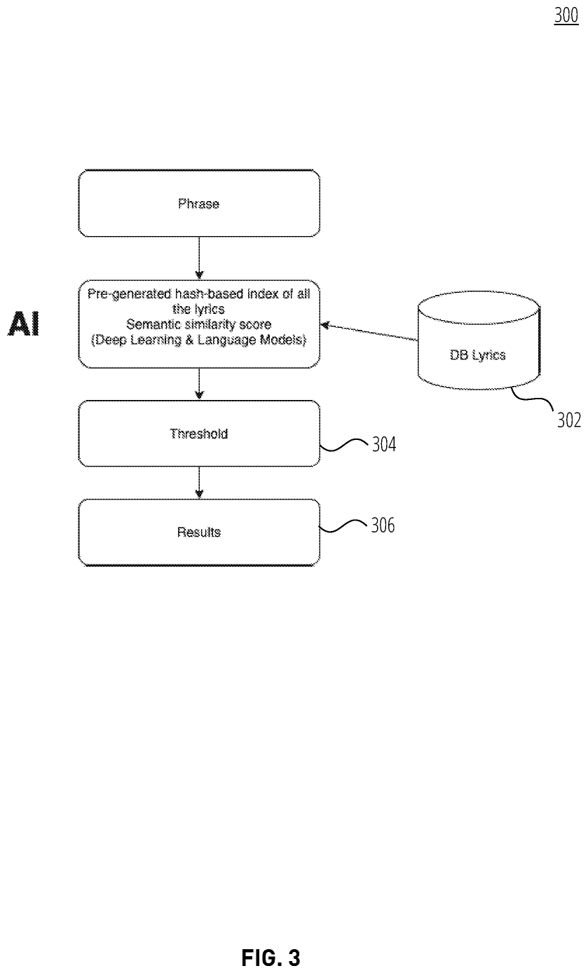

FIG. 3 illustrates a plagiarism detection pipeline according to some embodiments.

According to some embodiments, the plagiarism detection pipeline 300 supports the user flow of lyrics writing by suggesting if the written text is similar to any of the existing lyrics. For that purpose, we use a database 302 of publicly available lyrics in English (˜10,000,000) songs and we store it in a NoSQL database ElasticSearch. The text is encoded in semantic hashes (Rygl et al., 2017) which provides extremely fast results at scale (˜10 milliseconds per comparison against the whole database) indicating if two songs are similar to each other. If the similarity threshold 304 is higher than an arbitrary value defined during the user test, the song could be considered plagiarism in results.

The previously presented pipelines require a very efficient infrastructure to handle all the computational needs of Machine Learning algorithms and assure that the technical requirements are met.

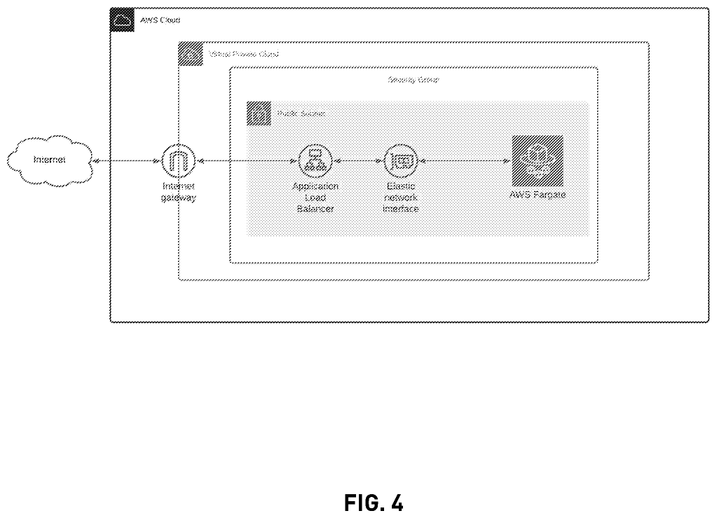

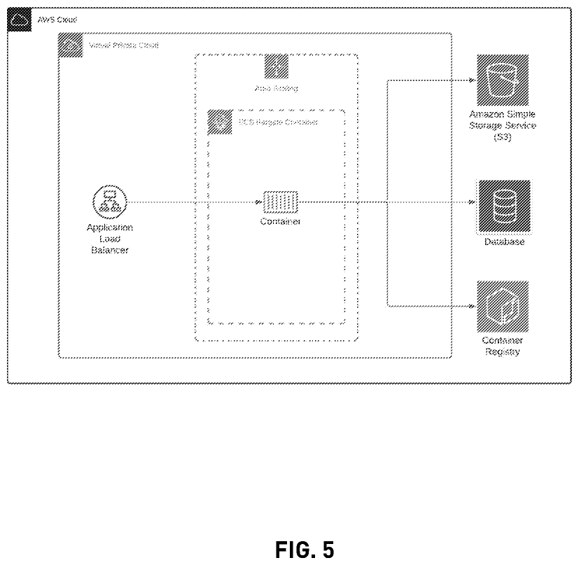

FIG. 4 illustrates an API architecture schema according to some embodiments. FIG. 5 illustrates an workers architecture schema according to some embodiments.

According to some embodiments, as shown in FIG. 4 and FIG. 5, a cloud-based scalable infrastructure designed for platforms such as Google Cloud or Amazon Web Services can be used. Our example may be based on the latter solution but can be easily translated to any cloud service. The Application Programming Interface ensures communication between a user (internet) and the application services. The modular architecture can be divided into a few parts. The internet gateway is a horizontally scaled, redundant, and highly available Virtual Private Cloud (VPC) component that allows communication between all services VPC and the internet. An internet gateway serves two purposes: to provide a target in the VPC route tables for internet-routable traffic and to perform network address translation (NAT) for instances that have been assigned public IPv4 addresses. Elastic Load Balancing automatically distributes incoming traffic across multiple targets, (AWS Fargate containers), and IP addresses, in one or more Availability Zones. It monitors the health of its registered targets and routes traffic only to the healthy targets. It directly communicates with the elastic network interface which in turn is a logical networking component in the VPC that represents a virtual network card. All services (models, data, etc.) use the serverless compute engine—AWS Fargate. It is essentially the heart of the system that ensures the functioning of all applications.

The containers allow running applications in the cloud without having to configure a special environment for the code. They also simplify to manage scalable applications that run on clusters—through application program interface (API). In order to deploy them reliably, we use the container registry which allows managing the application of the images and artifacts. All services running in the containers exchange the data with the database and the filesystem. The filesystem is managed by Amazon Simple Storage Service S3, and the database by Elasticsearch—a distributed search and analytics engine. However, this is a proposal, so the implementation is optional.

Techniques operating according to the principles described herein may be implemented in any suitable manner. Included in the discussion above are a series of flow charts showing the Steps and acts of various processes that determine whether a collision occurred and/or, if so, to characterize a collision. The processing and decision blocks of the flow charts above represent Steps and acts that may be included in algorithms that carry out these various processes. Algorithms derived from these processes may be implemented as software integrated with and directing the operation of one or more single- or multi-purpose processors, may be implemented as functionally-equivalent circuits such as a Digital Signal Processing (DSP) circuit or an Application-Specific Integrated Circuit (ASIC), or may be implemented in any other suitable manner. It should be appreciated that the flow charts included herein do not depict the syntax or operation of any particular circuit or of any particular programming language or type of programming language. Rather, the flow charts illustrate the functional information one skilled in the art may use to fabricate circuits or to implement computer software algorithms to perform the processing of a particular apparatus carrying out the types of techniques described herein. It should also be appreciated that, unless otherwise indicated herein, the particular sequence of Steps and/or acts described in each flow chart is merely illustrative of the algorithms that may be implemented and can be varied in implementations and embodiments of the principles described herein.

Accordingly, in some embodiments, the techniques described herein may be embodied in computer-executable instructions implemented as software, including as application software, system software, firmware, middleware, embedded code, or any other suitable type of computer code. Such computer-executable instructions may be written using any of a number of suitable programming languages and/or programming or scripting tools, and also may be compiled as executable machine language code or intermediate code that is executed on a framework or virtual machine.

When techniques described herein are embodied as computer-executable instructions, these computer-executable instructions may be implemented in any suitable manner, including as a number of functional facilities, each providing one or more operations to complete execution of algorithms operating according to these techniques. A “functional facility,” however instantiated, is a structural component of a computer system that, when integrated with and executed by one or more computers, causes the one or more computers to perform a specific operational role. A functional facility may be a portion of or an entire software element. For example, a functional facility may be implemented as a function of a process, or as a discrete process, or as any other suitable unit of processing. If techniques described herein are implemented as multiple functional facilities, each functional facility may be implemented in its own way; all need not be implemented the same way. Additionally, these functional facilities may be executed in parallel and/or serially, as appropriate, and may pass information between one another using a shared memory on the computer(s) on which they are executing, using a message passing protocol, or in any other suitable way.

Generally, functional facilities include routines, programs, objects, components, data structures, etc. that perform particular tasks or implement particular abstract data types. Typically, the functionality of the functional facilities may be combined or distributed as desired in the systems in which they operate. In some implementations, one or more functional facilities carrying out techniques herein may together form a complete software package. These functional facilities may, in alternative embodiments, be adapted to interact with other, unrelated functional facilities and/or processes, to implement a software program application.

Some exemplary functional facilities have been described herein for carrying out one or more tasks. It should be appreciated, though, that the functional facilities and division of tasks described is merely illustrative of the type of functional facilities that may implement the exemplary techniques described herein, and that embodiments are not limited to being implemented in any specific number, division, or type of functional facilities. In some implementations, all functionality may be implemented in a single functional facility. It should also be appreciated that, in some implementations, some of the functional facilities described herein may be implemented together with or separately from others (i.e., as a single unit or separate units), or some of these functional facilities may not be implemented.

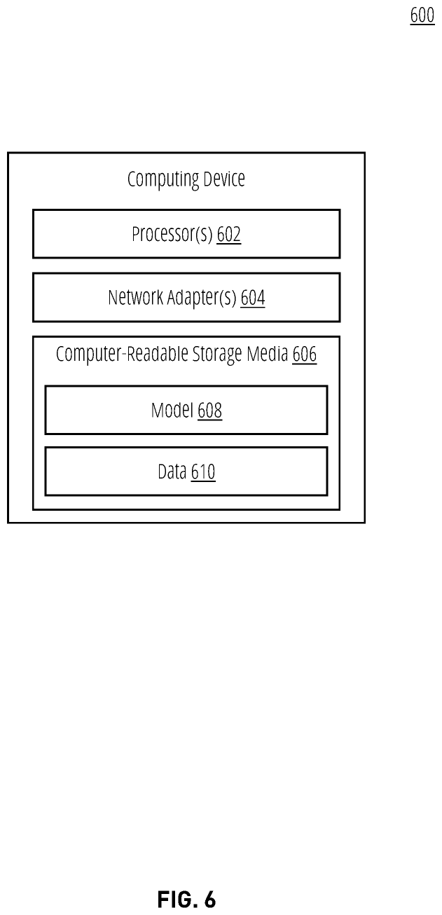

Computer-executable instructions implementing the techniques described herein (when implemented as one or more functional facilities or in any other manner) may, in some embodiments, be encoded on one or more computer-readable media to provide functionality to the media. Computer-readable media include magnetic media such as a hard disk drive, optical media such as a Compact Disk (CD) or a Digital Versatile Disk (DVD), a persistent or non-persistent solid-state memory (e.g., Flash memory, Magnetic RAM, etc.), or any other suitable storage media. Such a computer-readable medium may be implemented in any suitable manner, including as computer-readable storage media 606 of FIG. 6 described below (i.e., as a portion of a computing device 600) or as a stand-alone, separate storage medium. As used herein, “computer-readable media” (also called “computer-readable storage media”) refers to tangible storage media. Tangible storage media are non-transitory and have at least one physical, structural component. In a “computer-readable medium,” as used herein, at least one physical, structural component has at least one physical property that may be altered in some way during a process of creating the medium with embedded information, a process of recording information thereon, or any other process of encoding the medium with information. For example, a magnetization state of a portion of a physical structure of a computer-readable medium may be altered during a recording process.

In some, but not all, implementations in which the techniques may be embodied as computer-executable instructions, these instructions may be executed on one or more suitable computing device(s) operating in any suitable computer system, including the exemplary computer system of FIG. 6, or one or more computing devices (or one or more processors of one or more computing devices) may be programmed to execute the computer-executable instructions. A computing device or processor may be programmed to execute instructions when the instructions are stored in a manner accessible to the computing device or processor, such as in a data store (e.g., an on-chip cache or instruction register, a computer-readable storage medium accessible via a bus, a computer-readable storage medium accessible via one or more networks and accessible by the device/processor, etc.). Functional facilities comprising these computer-executable instructions may be integrated with and direct the operation of a single multi-purpose programmable digital computing device, a coordinated system of two or more multi-purpose computing device sharing processing power and jointly carrying out the techniques described herein, a single computing device or coordinated system of computing devices (co-located or geographically distributed) dedicated to executing the techniques described herein, one or more Field-Programmable Gate Arrays (FPGAs) for carrying out the techniques described herein, or any other suitable system.

FIG. 6 is a block diagram of a computer system with which some embodiments may operate.

FIG. 6 illustrates one exemplary implementation of a computing device in the form of a computing device 600 that may be used in a system implementing techniques described herein, although others are possible. It should be appreciated that FIG. 6 is intended neither to be a depiction of necessary components for a computing device to operate a bot detection framework in accordance with the principles described herein, nor a comprehensive depiction.

Computing device 600 may comprise at least one processor 602, a network adapter 604, and computer-readable storage media 606. Computing device 600 may be, for example, a server, including a web server, a server of a content delivery network (CDN), including of a point of presence (POP) of a CDN, a server of a cloud computing network or data center, or other suitable server. As another example, computing device 600 may be a desktop or laptop personal computer, a personal digital assistant (PDA), a smart mobile phone, or any other suitable computing device. Network adapter 604 may be any suitable hardware and/or software to enable the computing device 600 to communicate wired and/or wirelessly with any other suitable computing device over any suitable computing network. The computing network may include wireless access points, switches, routers, gateways, and/or other networking equipment as well as any suitable wired and/or wireless communication medium or media for exchanging data between two or more computers, including the Internet. Computer-readable storage media 606 may be adapted to store data to be processed and/or instructions to be executed by processor 602. Processor 602 enables processing of data and execution of instructions. The data and instructions may be stored on the computer-readable storage media 606.

The data and instructions stored on computer-readable storage media 606 may comprise computer-executable instructions implementing techniques which operate according to the principles described herein. In the example of FIG. 6, computer-readable storage media 606 stores computer-executable instructions implementing various facilities and storing various information as described above. Computer-readable storage media 606 may store a model 608 as described herein, and data 610 that includes song and lyric data, which may be collected for bot interactions and analyzed by the Model 608 and/or used to train a classifier of Model 608 for subsequent use in analyzing data regarding a bot interaction.

While not illustrated in FIG. 6, a computing device 600 may additionally have one or more components and peripherals, including input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computing device may receive input information through speech recognition or in other audible format.

Embodiments have been described where the techniques are implemented in circuitry and/or computer-executable instructions. It should be appreciated that some embodiments may be in the form of a method, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Various aspects of the embodiments described above may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” “having,” “containing,” “involving,” and variations thereof herein, is meant to encompass the items listed thereafter and equivalents thereof as well as additional items.

The word “exemplary” is used herein to mean serving as an example, instance, or illustration. Any embodiment, implementation, process, feature, etc. described herein as exemplary should therefore be understood to be an illustrative example and should not be understood to be a preferred or advantageous example unless otherwise indicated.

Having thus described several aspects of at least one embodiment, it is to be appreciated that various alterations, modifications, and improvements will readily occur to those skilled in the art. Such alterations, modifications, and improvements are intended to be part of this disclosure, and are intended to be within the spirit and scope of the principles described herein. Accordingly, the foregoing description and drawings are by way of example only.

What is claimed is:

1. A method comprising:
receiving, over a network, input provided by a user to a user device, the input comprising an input text that is at least a part of a line of lyrics of a song and a theme to be expressed by the lyrics of the song;
generating one or more proposals for a subsequent line of lyrics for the song, wherein generating each proposal of the one or more proposals for the subsequent line of lyrics comprises:
generating, based on the input text, a plurality of proposed rhymes for the subsequent line of lyrics, and
generating, using the plurality of proposed rhymes and the theme to be expressed and using at least one trained lyric generation model, text of the one or more proposals for the subsequent line of lyrics, each of the one or more proposals generated using the at least one trained lyric generation model contributing to expression of the theme by the song and including a rhyme of the plurality of proposed rhymes; and
outputting, for transmission to the user device over the network, the one or more proposals for the subsequent line of lyrics for the song.

2. The method of claim 1, wherein:
the method further comprises translating the input text into a phoneme sequence; and
generating the plurality of proposed rhymes comprises identifying rhymes based on the phoneme sequence for the input text.

3. The method of claim 2, wherein generating the plurality of proposed rhymes comprises:
identifying syllables comprising phonemes of the phoneme sequence of the input text; and
identifying, for the plurality of proposed rhymes, words or phrases that include one or more of the syllables and rhyme with the input text.

4. The method of claim 3, wherein determining words or phrases that include one or more of the syllables and rhyme with the input text comprise identifying words or phrases that include one or more of the syllables and are a perfect rhyme with the input text, a near rhyme with the input text, or an imperfect rhyme with the input text.

5. The method of claim 3, wherein determining words or phrases that include one or more of the syllables and rhyme with the input text comprise identifying words or phrases that include one or more of the syllables and are perfect rhymes, near rhymes, syllabic rhymes, assonance rhymes, identical rhymes, syllabic rhymes, and/or consonance rhymes with the input text.

6. The method of claim 1, wherein generating the plurality of proposed rhymes comprises generating the plurality of proposed rhymes using a lyric lexicon populated with words and phrases used in prior lyrics.

7. The method of claim 6, wherein:
the lyric lexicon is one of a plurality of lyric lexicons, each lyric lexicon populated with words and/or phrases used in songs of a musical type;
the input provided by the user further comprises an indication of a musical type of the song; and
generating the plurality of proposed rhymes comprises selecting the lyric lexicon based on the indication of the musical type of the song.

8. The method of claim 6, wherein generating the plurality of proposed rhymes comprises determining, for each of the plurality of proposed rhymes, a frequency of appearance in the prior lyrics.

9. The method of claim 8, wherein generating the plurality of proposed rhymes comprises:
selecting a perfect rhymes set and a near rhymes set from potential rhymes for the input text;
selecting a subset of the perfect rhymes set based on frequency of appearance and ordering the subset based on the frequency of appearance of each rhyme in the subset;
selecting a subset of the near rhymes set based on frequency of appearance and ordering the subset based on the frequency of appearance of each rhyme in the subset; and
generating the plurality of proposed rhymes based on the subset of the perfect rhymes set and the subset of the near rhymes set.

10. The method of claim 1, wherein generating the one or more proposals for the subsequent line of lyrics comprises filtering from the one or more proposals any proposal generated by the at least one trained lyric generation model that matches a previously-published lyric.

11. The method of claim 1, wherein:
the input provided by the user further comprises an indication of a musical type of the song;
generating the one or more proposals for the subsequent line of lyrics using at least one trained lyric generation model comprises:
selecting a trained lyric generation model that was trained for generation of lyrics in songs of the musical type indicated by the indication; and
generating the one or more proposals using the trained lyric generation model.

12. The method of claim 1, wherein:
the at least one trained lyric generation model comprises a user-specific lyric generation model; and
the method further comprises training the user-specific lyric generation model based on lyrics of the user.
